(19) United States
(12) Patent Application Publication
(10) Pub. No.: US 2023/0055488 A1
(43) Pub. Date: Feb. 23, 2023

(54) METHOD AND SYSTEM FOR EXTRACTING AND CLASSIFYING MANUFACTURING FEATURES FROM THREE-DIMENSIONAL MODEL OF PRODUCT

(71) Applicant: HCL Technologies Limited, New Delhi (IN)

(72) Inventors: Deepesh Ojha, Mumbai (IN); Christine Zuzart, Pune (IN); Arvind Maurya, Noida (IN)

(73) Assignee: HCL Technologies Limited

(21) Appl. No.: 17/524,764

(22) Filed: Nov. 12, 2021

(30) Foreign Application Priority Data
Aug. 14, 2021 (IN) 202111036918

(51) Int. Cl. G06N 3/04; G06N 3/08; G06F 17/16; G06F 30/10

(52) U.S. Cl. CPC G06N 3/04; G06N 3/08; G06F 17/16; G06F 30/10; G06F 2119/18

(57) ABSTRACT

The invention relates to method and system for extracting and classifying manufacturing features from a three-dimensional (3D) model of a product. The method includes generating graph corresponding to product based on 3D model of product. The graph includes nodes corresponding to faces of the product and links corresponding to edges of product. The graph generation includes determining adjacency attribute matrix from the 3D model. The method further includes assigning scores to each of links; determining a cumulative score for each of links; extracting sub-graphs from graph by discarding one or more links from links; extracting node parameters and edge parameters from 3D model of product; determining node feature vector based on node parameters and edge feature vector based on edge parameters; and determining a type of manufacturing feature based on corresponding node feature vector and edge feature vector using a Graph Neural Network (GNN) model.

### TECHNICAL FIELD

Generally, the invention relates to manufacturing processes. More specifically, the invention relates to a method and system for extracting and classifying manufacturing features from a three-dimensional model of a product.

### BACKGROUND

A manufacturing feature in context of Computer Aided Manufacturing (CAM) is defined by set of topological entities, namely faces and edges within a Boundary Representation (B-Rep) based 3D model. The manufacturing feature may be a result of certain manufacturing process like casting, forming, material removal, and the like, being performed to achieve a reference topological shape. Further, the Computer Aided Design (CAD) models employ design features such as, extrude, revolve, and Boolean operations, in order to create geometrical shapes. Therefore, additional processing is required for extracting higher-level features, i.e., manufacturing features. Typically, extraction of the higher-level manufacturing features from the CAD models is done algorithmically and commonly by a Feature Recognition (FR) technique. The FR technique automates the flow from CAD to CAM, therefore integration of both is essential building block of Computer Integrated Manufacturing (CIM) systems. Further, the FR technique also have an application in Manufacturability evaluation and cost assessment.

Today, various systems and methods are available for feature recognition. The available systems fail to recognize even when a minor variation in the feature is identified. Further, the available systems for feature recognition use a rule-based approach where each feature is defined with distinctive set of rules and recognition is carried out by assessment against these predefined set of rules. However, the rules must be developed for each and every feature which is time consuming and requires expert knowledge. Additionally, some of the available systems matches a feature template with original graph. Template matching is computationally expensive and may be incapable of handling minor variations in features. Moreover, some of the available systems are difficult to scale and loose the B-rep relationship due to use of voxel data structure.

### SUMMARY

In one embodiment, a method for extracting and classifying manufacturing features from a three-dimensional (3D) model of a product is disclosed. The method may include generating a graph corresponding to the product based on the 3D model of the product. It should be noted that the graph may include a plurality of nodes corresponding to faces of the product and a plurality of links corresponding to edges of the product. The graph may be generated by determining an adjacency attribute matrix from the 3D model of the product. The method may further include assigning a plurality of scores to each of the plurality of links based on each of a plurality of predefined criteria, based on corresponding edges of the product in the 3D model of the product. The method may further include determining a cumulative score for each of the plurality of links based on the plurality of scores assigned to the each of the plurality of links. The method may further include extracting sub-graphs from the graph by discarding one or more links from the plurality of links when the cumulative score of each of the one or more links exceeds a predefined threshold value. The method may further include extracting a set of node parameters and a set of edge parameters from the 3D model of the product for each of the sub-graphs. The method may further include determining a node feature vector based on the set of node parameters and an edge feature vector based on the set of edge parameters for each of the sub-graphs. The method may further include determining a type of manufacturing feature based on corresponding node feature vector and the edge feature vector using a Graph Neural Network (GNN) model for each of the sub-graphs. A confidence score may be assigned to each of the subgraphs corresponding to the type of manufacturing feature.

In another embodiment, a system for extracting and classifying manufacturing features from a three-dimensional (3D) model of a product is disclosed. The system may include a processor and a memory communicatively coupled to the processor. The memory may store processor-executable instructions, which, on execution, may cause the processor to generate a graph corresponding to the product based on the 3D model of the product. It should be noted that the graph may include a plurality of nodes corresponding to faces of the product and a plurality of links corresponding to edges of the product. The graph may be generated by determining an adjacency attribute matrix from the 3D model of the product. The processor-executable instructions, on execution, may further cause the processor to assign a plurality of scores to each of the plurality of links based on each of a plurality of predefined criteria, based on corresponding edges of the product in the 3D model of the product. The processor-executable instructions, on execution, may further cause the processor to determine a cumulative score for each of the plurality of links based on the plurality of scores assigned to the each of the plurality of links. The processor-executable instructions, on execution, may further cause the processor to extract sub-graphs from the graph by discarding one or more links from the plurality of links when the cumulative score of each of the one or more links exceeds a predefined threshold value. The processor-executable instructions, on execution, may further cause the processor to extract a set of node parameters and a set of edge parameters from the 3D model of the product for each of the sub-graphs. The processor-executable instructions, on execution, may further cause the processor to determine a node feature vector based on the set of node parameters and an edge feature vector based on the set of edge parameters for each of the sub-graphs. The processor-executable instructions, on execution, may further cause the processor to determine a type of manufacturing feature based on corresponding node feature vector and the edge feature vector using a Graph Neural Network (GNN) model. A confidence score may be assigned to each of the sub-graphs corresponding to the type of manufacturing feature.

In yet another embodiment, a non-transitory computer-readable medium storing computer-executable instruction for extracting and classifying manufacturing features from a three-dimensional (3D) model of a product is disclosed. The stored instructions, when executed by a processor, may cause the processor to perform operations including generating a graph corresponding to the product based on the 3D model of the product. It should be noted that the graph may include a plurality of nodes corresponding to faces of the product and a plurality of links corresponding to edges of the product. The graph may be generated by determining an adjacency attribute matrix from the 3D model of the product. The operations may further include assigning a plurality of scores to each of the plurality of links based on each of a plurality of predefined criteria, based on corresponding edges of the product in the 3D model of the product. The operations may further include determining a cumulative score for each of the plurality of links based on the plurality of scores assigned to the each of the plurality of links. The operations may further include extracting sub-graphs from the graph by discarding one or more links from the plurality of links when the cumulative score of each of the one or more links exceeds a predefined threshold value. The operations may further include extracting a set of node parameters and a set of edge parameters from the 3D model of the product for each of the sub-graphs. The operations may further include determining a node feature vector based on the set of node parameters and an edge feature vector based on the set of edge parameters. The operations may further include determining a type of manufacturing feature based on corresponding node feature vector and the edge feature vector using a Graph Neural Network (GNN) model for each of the sub-graphs. A confidence score may be assigned to each of the subgraphs corresponding to the type of manufacturing feature.

It is to be understood that both the foregoing general description and the following detailed description are exemplary and explanatory only and are not restrictive of the invention, as claimed.

### BRIEF DESCRIPTION OF THE DRAWINGS

The present application can be best understood by reference to the following description taken in conjunction with the accompanying drawing figures, in which like parts may be referred to by like numerals.

FIG. 1 illustrates a functional block diagram of an exemplary feature Identification device for extracting and classifying manufacturing features from a three-dimensional (3D) model of a product, in accordance with some embodiments of the present disclosure.

FIG. 2 illustrates a flow diagram of an exemplary process for extracting and classifying manufacturing features from a three-dimensional (3D) model of a product, in accordance with some embodiments of the present disclosure.

FIGS. 3A, 3B, and 3C illustrate an exemplary 3D model of a product with a pocket feature, corresponding an adjacency attribute matrix, and a graph corresponding to the product based on the 3D model of the product respectively, in accordance with some embodiments of the present disclosure.

FIGS. 3D and 3E illustrate exemplary extracted of sub-graphs from the graph of a 3D model, in accordance with some embodiments of the present disclosure.

FIGS. 4A and 4B illustrate exemplary node feature vector table and edge feature vector table, in accordance with some embodiments of the present disclosure.

FIG. 5 is a block diagram of an exemplary computer system for implementing embodiments consistent with the present disclosure.

### DETAILED DESCRIPTION OF THE DRAWINGS

The following description is presented to enable a person of ordinary skill in the art to make and use the invention and is provided in the context of particular applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the description of the invention with unnecessary detail. Thus, the present invention is not intended to be limited to the embodiments shown, but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

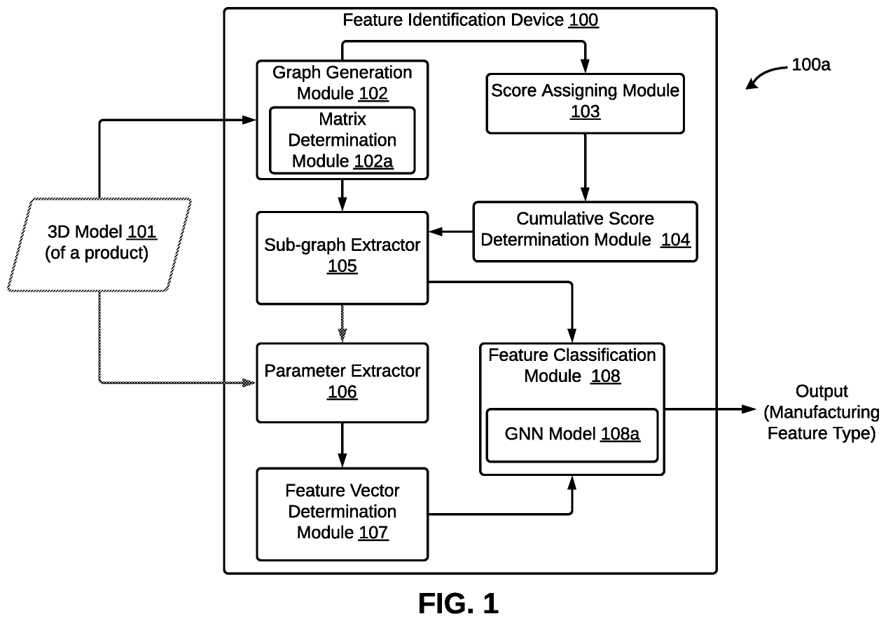

Referring now to FIG. 1, a block diagram of an exemplary system 100a for extracting and classifying manufacturing features from a three-dimensional (3D) model of a product is illustrated, in accordance with some embodiments of the present disclosure. The system 100a includes a feature identification device 100. In some embodiments, the 3D model 101 of the product may be a 3D Computer Aided Design (CAD) model of the product. Further, in some other embodiments, a boundary representation (B-rep) based Computer Aided Design (CAD) model.

The feature identification device 100 may perform various operations to identify the manufacturing feature of the product. Further, to perform various operations, the feature identification device 100 may include a graph generation module 102, a score assigning module 103, a cumulative score determination module 104, a sub-graph extractor 105, a parameter extractor 106, a feature vector determination module 107, and a feature classification module 108. Additionally, the feature identification device 100 may also include a data store (not shown in FIG. 1) to store various data and intermediate results generated by the modules 102-108.

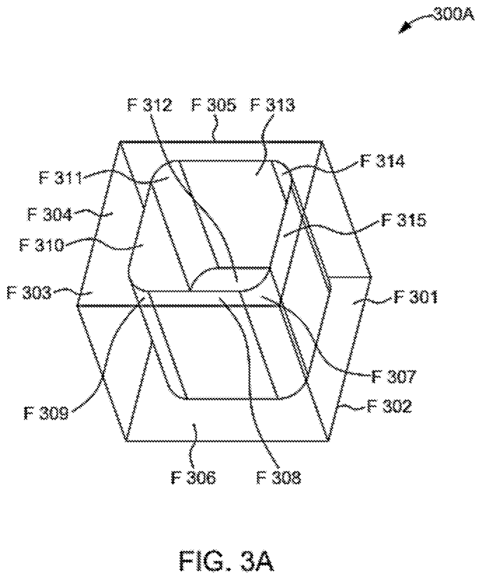

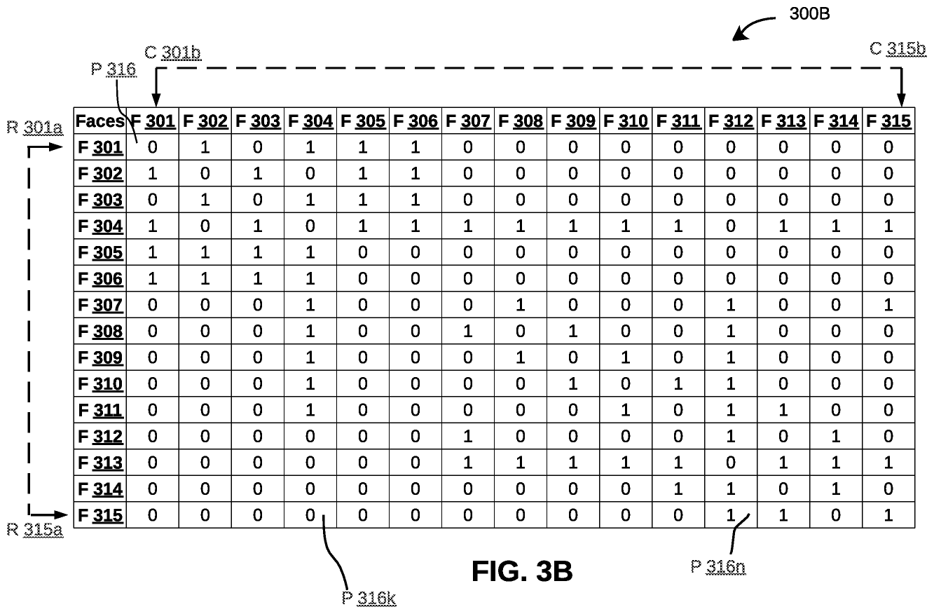

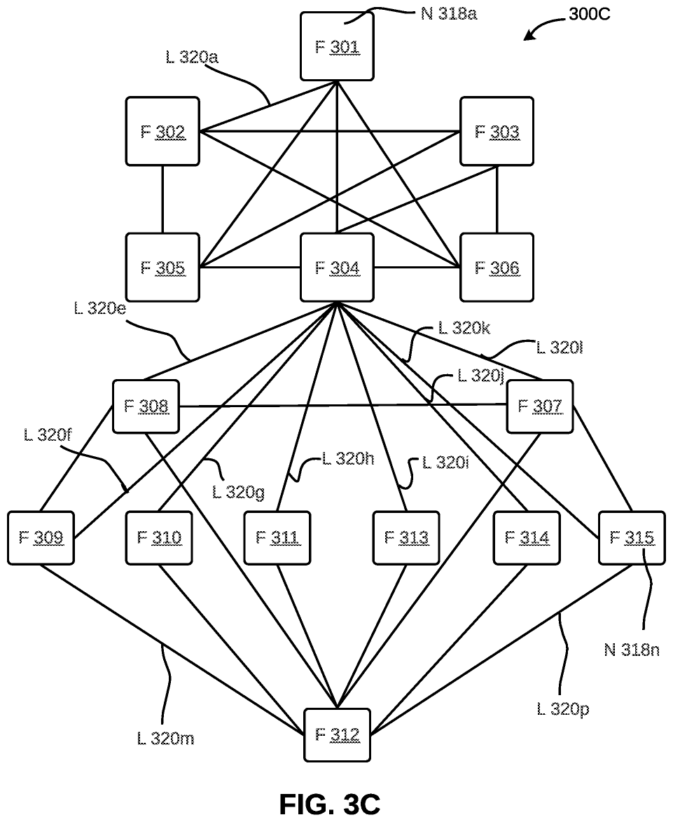

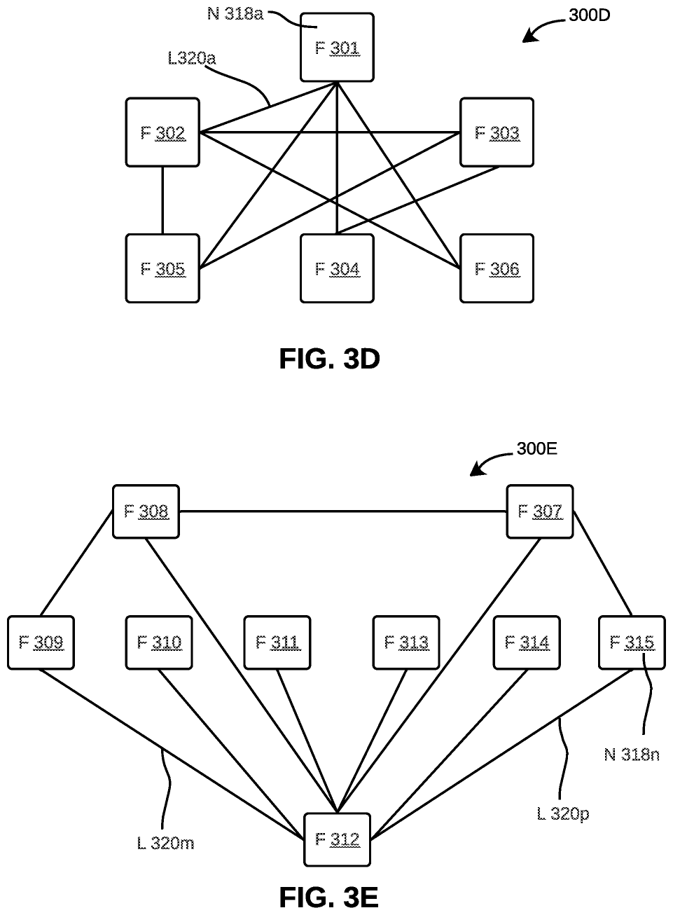

The graph generation module 102 may be configured to receive the 3D model 101 of the product. The graph generation module 102 may generate a graph corresponding to the product based on the 3D model 101 of the product. It should be noted that the graph may include plurality of nodes corresponding to faces of the product and a plurality of links corresponding to edges of the product. Further, the graph generation module 102 may include a matrix determination module 102a, which may be configured for determining an adjacency attribute matrix from the 3D model 101 of the product. The adjacency attribute matrix may represent topological relations among the plurality of faces. Further, the adjacency attribute matrix may include a plurality of rows and a plurality of columns corresponding to faces of the product. The plurality of matrix elements represents connection between two faces of the product. Graph generation and adjacency attribute matrix determination from the 3D model 101 of the product may be further explained in conjunction with FIGS. 3A-C. The graph generation module may be communicatively coupled to the score assigning module 103 and sub-graph extractor 105.

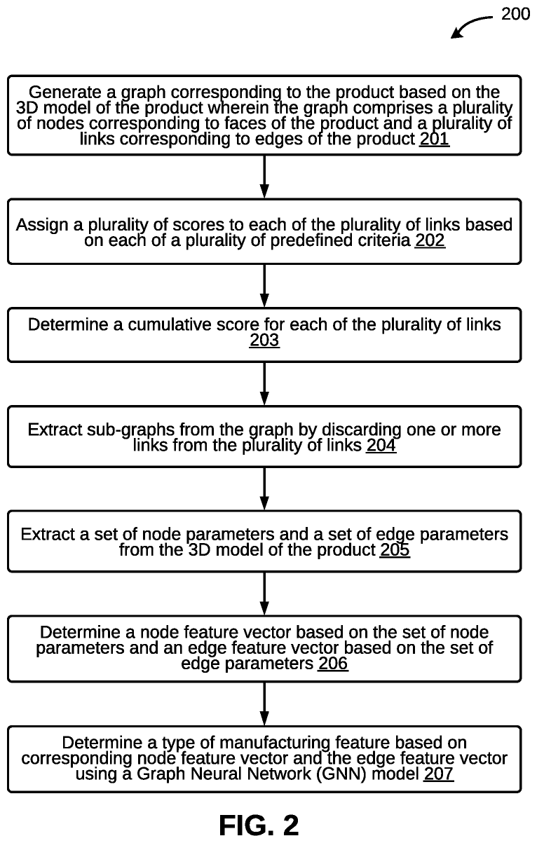

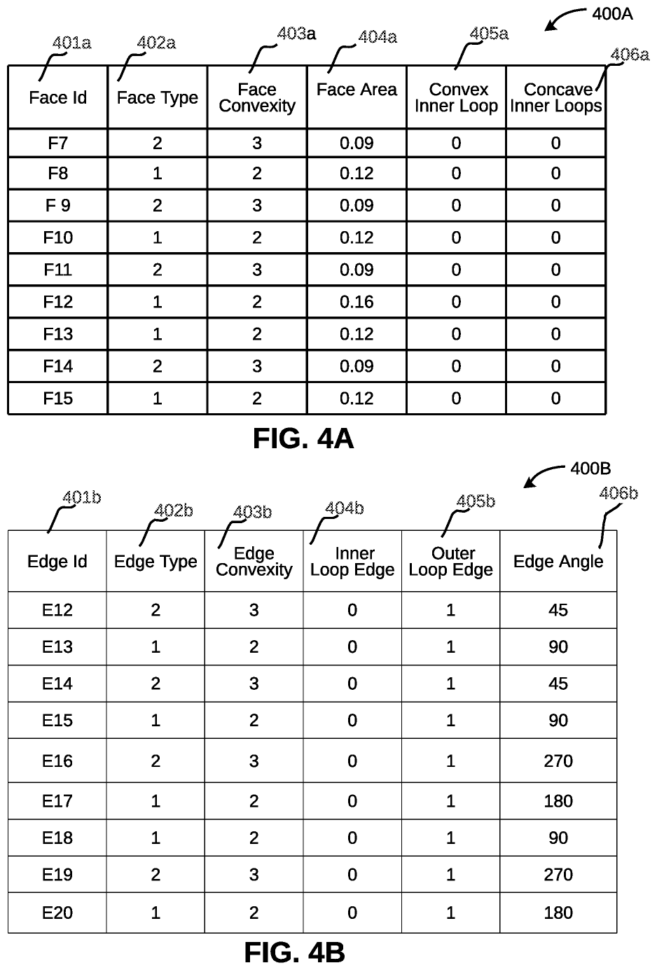

The score assigning module 103 may be configured to assign a plurality of scores to each of the plurality of links of the graph. The plurality of scores may be assigned by the score assigning module 103 based on a plurality of predefined criteria and corresponding edges of the product in the 3D model 101 of the product. In other words, for extracting individual features, the score assigning module 103 may assign scores to each of the plurality of links of the graph corresponding to each of the plurality edges of the 3D model 101 based on the plurality of pre-defined criteria. In some embodiments, the plurality of criteria may include presence of a loop type, convexity of vertices, and neighbor convexity variation. The plurality of predefined criteria is explained in conjunction with FIG. 2 and FIG. 4. Further, the score assigning module 103 may be communicatively coupled to the cumulative score determination module 104. The cumulative score determination module 104 may be configured to determine a cumulative score for each of the plurality of links. The cumulative score may be determined based on based on the plurality of scores assigned to the each of the plurality of links. It should be noted that scores after applying each criterion from the plurality of criteria may be added to arrive at the cumulative score. Further, the cumulative score determination module 104 may be communicatively coupled to the sub-graph extractor 105.

The sub-graph extractor 105 may be configured receive the cumulative score for each of the plurality of links from the cumulative score determination module 104. Further, the sub-graph extractor 105 may extract sub-graphs from the graph by discarding one or more links from the plurality of links based on the cumulative score. For example, when the cumulative score the one or more links exceed a predefined threshold value, the sub graph extractor 105 may discard the one or more links in order to extract the sub graphs. In some embodiments, the one or more links with final weight more than ‘10’ may be discarded. In some embodiments, the weight may correspond to the score and the final weight may correspond to the cumulative score. As a result of neglecting these one or more links, the graph may be subdivided into disconnected smaller graphs or sub-graphs. The sub-graph extractor 105 may be further connected to the parameter extractor 106.

The parameter extractor 106 may extract a set of node parameters and a set of edge parameters from the 3D model 101 of the product for each of the sub graphs. For example, the set of node parameters may include, but not limited to, a face type, face smoothness, face convexity, face area, and presence of inner loop, and the set of edge parameters comprises an edge type, edge convexity, inner loop edge, outer loop edge, and edge angle. Further the parameter extractor 106 may transmit the extracted set of node and edge parameters to the connected feature vector determination module 107, which may be configured to determine a node feature vector and an edge feature vector based on the set of node parameters and the set of edge parameters, respectively, for each of the sub-graphs. The feature vector determination module 107 may be communicatively connected to the feature classification module 108.

The feature classification module 108 may be configured to determine to a type of manufacturing feature for each of the sub graphs. It should be noted that the feature classification module 108 may determine the type based on corresponding node feature vector and the edge feature vector. In particular, the feature classification module 108 may include a Graph Neural Network (GNN) model 108a. In some embodiments, the GNN model 108a may be trained using a dataset that may include a set of graphs that represents a plurality of manufacturing features. The GNN model 108a may include a set of graph convolution layers, a set of corresponding pooling layers, and a fully connected dense layer. Moreover, each of the set of convolution layers is followed by each of the set of corresponding pooling layer. The GNN model 108a may assign a confidence score to each of the sub-graphs. The assigned score may correspond to the type of manufacturing feature. The GNN model 108a uses a negative log-likelihood loss function to determine the type of manufacturing feature. The model is trained on a predefined set of manufacturing features (for example, a pocket, a slot, a hole, etc.) which may be represented as graphs. Thus, the feature classification module 108 may be able to identify type of manufacturing feature with the help of the GNN model 108a.

It should be noted that the feature identification device 100 may be implemented in programmable hardware devices such as programmable gate arrays, programmable array logic, programmable logic devices, or the like. Alternatively, the feature identification device 100 may be implemented in software for execution by various types of processors. An identified engine/module of executable code may, for instance, include one or more physical or logical blocks of computer instructions which may, for instance, be organized as a component, module, procedure, function, or other construct. Nevertheless, the executables of an identified engine/module need not be physically located together but may include disparate instructions stored in different locations which, when joined logically together, comprise the identified engine/module and achieve the stated purpose of the identified engine/module. Indeed, an engine or a module of executable code may be a single instruction, or many instructions, and may even be distributed over several different code segments, among different applications, and across several memory devices.

As will be appreciated by one skilled in the art, a variety of processes may be employed for extracting and classifying manufacturing features from a three-dimensional (3D) model of a product. For example, the exemplary system 100a and associated feature identification device 100 may identify the type of manufacturing feature, by the process discussed herein. In particular, as will be appreciated by those of ordinary skill in the art, control logic and/or automated routines for performing the techniques and steps described herein implemented by the system 100a and the associated feature identification device 100 either by hardware, software, or combinations of hardware and software. For example, suitable code may be accessed and executed by the one or more processors on the system 100a to perform some or all of the techniques described herein. Similarly, application specific integrated circuits (ASICs) configured to perform some or all the processes described herein may be included in the one or more processors on the system 100a.

Referring now to FIG. 2, an exemplary process 200 for extracting and classifying manufacturing features from a three-dimensional (3D) model of a product is depicted via a flow diagram 200, in accordance with some embodiments of the present disclosure. Each step of the process may be performed by a feature identification device (similar to the feature identification device 100). FIG. 2 is explained in conjunction with FIG. 1.

At step 201, a graph corresponding to the product based on the 3D model of the product may be generated. In some embodiments, it should be noted that the 3D model is a boundary representation (B-rep) based Computer Aided Design (CAD) model. The graph may be generated by a graph generation module (similar to the graph generation module 102). It should be noted that the graph may include a plurality of nodes corresponding to faces of the product and a plurality of links corresponding to edges of the product. In some embodiments, an adjacency attribute matrix may be determined from the 3D model of the product by a matrix determination module (same as the matrix determination module 102a). The adjacency attribute matrix may include a plurality of rows and a plurality of columns corresponding to faces of the product. Therefore, in some embodiments the plurality of rows and the plurality of columns of the adjacency attribute matrix may be equal. Further, a plurality of matrix elements representing connection between two faces of the product.

At step 202, a plurality of scores may be assigned to each of the plurality of links based on each of a plurality of predefined criteria and corresponding edges of the product in the 3D model of the product using a score assigning module (analogous to the score assigning module 103). Moreover, in some embodiments, the plurality of predefined criteria may include at least one of presence of a loop type, convexity of vertices, and neighbour convexity variation. Thereafter, at step 203, a cumulative score may be determined for each of the plurality of links based on the plurality of scores assigned to the each of the plurality of links using a cumulative score determination module (similar to the cumulative score determination module 104).

At step 204, sub-graphs from the graph may be extracted from the graph. The sub-graphs may be extracted using a sub-graph extractor (analogous to the sub-graph extractor 105). In some embodiments, one or more links from the plurality of links may be discarded to generate the sub-graphs. The one or more links may be discarded based on the cumulative score of each of the one or more links (for example, when the cumulative of each of the one or more links exceeds a predefined threshold value).

At step 205, a set of node parameters and a set of edge parameters may be extracted parameters from the 3D model of the product. To extract the set of node parameters and a set of edge parameters a parameter extractor may be employed (such as, the parameter extractor 106). The set of node parameters and the set of edge parameters may be extracted for each of the sub-graphs. It should be noted that the set of node parameters may include, but not limited to, a face type, face smoothness, face convexity, face area, and presence of inner loop. And, the set of edge parameters may include, but not limited to, an edge type, edge convexity, inner loop edge, outer loop edge, and edge angle.

At step 206, a node feature vector and an edge feature vector may be determined for each of the sub-graphs. The node feature vector may be determined based on the set of node parameters and the edge feature vector may be determined based on the set of edge parameters.

At step 207, a type of manufacturing feature for each of the sub-graphs may be determined. It should be noted that corresponding node feature vector and the edge feature vector may be considered to determine the type of the manufacturing feature. Additionally, it should be noted that using a Graph Neural Network (GNN) model of a feature classification module (same as the GNN model 108a of the feature classification module 108) may be utilized for determination of the type of manufacturing feature. In some embodiments, a confidence score may be assigned to each of the sub-graphs corresponding to the type of manufacturing feature. The GNN model may include a set of graph convolution layers, a set of corresponding pooling layers, and a fully connected dense layer. It may be apparent to those skilled in the art that in a GNN model the set of convolution layers may be followed by each of the set of corresponding pooling layers. Further, the GNN model may use a negative log-likelihood loss function to determine the type of manufacturing feature. It should be noted that the type of manufacturing feature may be at least one of a pocket, a slot, a boss, a groove, and a hole. Additionally, in some embodiments, the GNN model may be trained using a dataset including a set of graphs that represents a plurality of manufacturing features. The model is trained on a predefined set of features. (for example, pocket, slot, hole, etc.) which are represented as graphs. This trained model is then deployed in the final system to predict the manufacturing feature type.

In some embodiments, a GNN model may be trained on a predefined set of features, for example, a pocket feature, a slot, and a hole that may be a graphical representation. Further, a trained GNN model is capable to predict the manufacturing feature type. With the features represented as graphs, the GNN is trained in a supervised manner for manufacturing feature classification. The GNN uses deep learning methods to perform inference on graphical data inputs and is effective for representation learning on graphs. The GNN follows a neighborhood aggregation scheme, where a node vector is computed by recursive aggregation and transformation of neighboring node vectors and incident edge vectors. The aggregation scheme may be termed as a message passing scheme in the GNN. Thus, after k number of iterations of aggregation the transformed feature vector of the node captures structural information with the nodes of k-hop neighborhood. The representation of the entire graph is obtained through the pooling layers.

Referring now to FIGS. 3A, 3B, and 3C, an exemplary 3D model 300A of a product, a corresponding adjacency attribute matrix 300B, and a graph 300C corresponding to the product based on the 3D model 300A of the product, respectively, are illustrated, in accordance with some embodiments of the present disclosure. FIGS. 3A, 3B, and 3C are explained in conjunction with FIGS. 1 and 2. As illustrated in FIG. 3A, the product corresponding to the 3D model 300A may have pocket feature which needs to be extracted and identified by a feature identification device (similar to the feature identification device). The 3D model 300A is a boundary representation (B-rep) based Computer Aided Design (CAD) model. Further, the 3D model 300A may have a plurality of faces F 301-F 315, as illustrated in FIG. 3A. Each adjacent pair of the faces F 301-F 315 shares at least one edge.

Referring to the FIG. 3B, the adjacency attribute matrix 300B corresponding to the 3D model 300A may be generated by a matrix determination module (similar to the matrix determination module 102a). It should be noted that after iterating through all the faces F 301-F 315 and corresponding edges of the 3D model 300A, topological relation may be extracted to populate the adjacency attribute matrix 300B. The adjacency attribute matrix 300B includes a plurality of rows R 301a-R 315a and a plurality of columns C 301b-C 315b. In the matrix representation (i.e., the adjacency attribute matrix 300B) of the 3D model 300A may have both the plurality of rows R 301a-R 315a and the plurality of columns C 301b-C 315b equal to a number of faces F 301-F 315 of the 3D model 300A. Further, the adjacency attribute matrix 300B may include a plurality of matrix elements (for example, a matrix element P 316, P 316k and P 316n). Each matrix element of the adjacency attribute matrix 300B represents a connection between a row and a column. Hence, each matrix element is corresponding to an edge of the 3D model 300A representing connection of two faces. For example, the matrix element P 316k represents connection between the face F 304 and face F 315. Each matrix element is represented by either ‘0’ or ‘1’. Here, ‘1’ represents presence of an edge or connection between corresponding row and column faces, and ‘0’ represents that absence of an edge or no connection between the corresponding faces. For example, the value of matrix element P 316k is ‘0’ due to absence of an edge between the face F 304 and face F 315, and value of matrix element P 316n is ‘1’ due to presence of an edge between the face F 312 and face F 315, as illustrated in FIGS. 3A and 3B.

Referring to FIG. 3C, the graph 300C may be generated based on the 3D model 300A. The graph 300C includes a plurality of nodes N 318a to N 318n equal to the number of faces (F 301-F 315) of the 3D model 300A. Further, the graph 300C includes a plurality of links connecting the faces F 301-F 315, for example links L 320a, L 320e-L 320i, L 320m and L 320p. Each of the plurality of links represents presence of connections between two faces.

In some embodiments, for extracting individual features, all faces F 301-F 315 of 3D model 300A model may be iterated, and further each link corresponding to each edge between two faces may be assigned with different score based on a plurality of predefined criteria. For example, each of the links of the graph 300C may be assigned with different scores based on the plurality of predefined criteria. Since in the 3D model 300A edge is shared by two faces, each edge occurs twice in each step. Further, in some embodiments, scores assigned for each criterion may be added to determine a cumulative score. The plurality of predefined criteria includes presence of a loop type, convexity of vertices, and neighbour convexity variation.

In detail, in some embodiments, there may be three predefined criteria to assign the scores to the plurality of links of the graph 300C. Moreover, in a first criteria of the three predefined criteria, a score may be assigned based on whether an edge corresponding to a link is a part of an inner loop or not. In case the edge is a part of the inner loop, a score of ‘5’ may be assigned to the corresponding link, otherwise the assigned score may be ‘1’ for the corresponding link. It should be noted that the scores 1 and 5 are selected for better precision for identifying sub-matrices. In some other embodiments, the scores may vary based on user requirements.

Further, in a second criteria, the score may be assigned based on if convexity of vertices of edges corresponding to the links is similar or not. In case of difference in convexity (i.e., one vertex is concave and other vertex is convex), a score of ‘5’ may be assigned to a corresponding link and it may be marked with a tag of varying convexity. Further, if both the vertices are of similar convexity (i.e., both the vertices are convex or concave), the link may be assigned with a score of ‘1’ and marked with a tag of uniform convexity. Further, in a third criteria, the links corresponding to the edges with neighboring faces of different convexity may be assigned with a score of ‘5’, else a score of ‘1’ may be assigned.

By way of an example, each of the links between the faces F 301-F 305 and F 307-F 312 may be assigned with a score of ‘2’ (i.e., ‘1’ for each face, as each link is shared by two faces), and a score of ‘6’ may be assigned to the links L 320e-L 320l (i.e, ‘5’ corresponding to one face and ‘1’ corresponding to another face), based on the first criteria. Further, based on second criteria each of the plurality of links of the graph 300C may be assigned with a score ‘2’. Further, the scores of first criteria and the second criteria may be added to get a new score for each of the plurality of links. Therefore, a new score for the links between the faces F 301-F 305 and F 307-F 312 become ‘4’, and a new score for the links L 320e-L 320l may be ‘8’.

Further, based on the third criteria, each of the plurality of links of the graph 300C may be assigned with a score ‘2’, which may be added to the new score generated after the addition of scores of first and second criteria. Therefore, a cumulative score (addition of the score of all the three criteria) may be ‘6’, for the links between the faces F 301-F 305 and F 307-F 312. And the cumulative score for each of the links L 320e-L 320l may be ‘10’.

By way of an example, following pseudo-code may be used to assign scores based on the first criteria, the second criteria, and the third criteria corresponding to the edge:

```
Subroutine: EdgeScoring
Input: Set of all Faces F (F₁, ..., Fₖ)
for each F ∈ F do
  E:=GetAllEdges(Fᵢ)
  for each Eⱼ ∈ E do
    if Eⱼ IsInnerLoop then \\ Criteria 1
      SEᵢⱼ = 5
    else if Eⱼ IsVaryingVertexConvexity \\ Criteria 2
      SEᵢⱼ = 5
    else if Eⱼ HasVaryingConvextityNeighbors \\ Criteria 3
      SEᵢⱼ = 5
    else
      SEᵢⱼ = 1
    end if
  end for
end for
```

where:
F: Set of all faces (F₁ . . . Fₖ)
E: Set of all Edges belonging to F. (E₁ . . . Eₖ)
SEᵢⱼ: Edge Score for edge Eⱼ of face Fᵢ

By way of an example, following pseudo-code may be used to establish the second criteria for the edge:

```
Subroutine: IsVarying VertexConvexity
Input: Edge E
{V₁,V₂}:= GetVertices(E)
  if CV₁ = CV₂
    return False;
  else
    return True
  end if
```

where:

### E: Input Edge E

### V₁: Vertex 1 of Edge E

### V₂: Vertex 2 of Edge E

### CV₁: Convexity of Vertex 1 of Edge E

### CV₂: Convexity of Vertex 2 of Edge E

By way of an example, following pseudo-code may be used to establish the third criteria for the edge:

```
Subroutine: HasVaryingConvexity Neighbors
Input: Edge E
NE:= GetNeighborEdges(Fⱼ)
  for each NEⱼ ∈ NE do
    if NOT IsVaryingVertexConvexity(NEⱼ) then
      return false
    end if
  end for
return True
```

where:

### E: Input Edge E

NE: Set of all neighbor Edges of E

Referring now to FIGS. 3D and 3E, exemplary extracted of sub-graphs 300D and 300E from the graph 300C of a 3D model 300A are illustrated, in accordance with some embodiments of the present disclosure. In order to extract the sub-graphs 300D and 300E from the graph 300C one or more links may be discarded when the cumulative score of each of the one or more links exceeds a predefined threshold value. In continuation of the above explained example in FIG. 3C, the links L 320f-L 320l may be discarded to get the sub-graphs 300D and 300E. For example, the predefined threshold in this case may be ‘10’. Hence, the links with cumulative scores more than of equal to ‘10’ may be discarded. As a result of neglecting the links L 320e-L 320l, the graph 300C may be subdivided into disconnected smaller graphs. Each of the sub-graphs 300D and 300E may be selected as a feature cluster and is defined by the list of faces. Collection of all the feature clusters may be represented by a list of lists, e.g. [F1, F2, F3, F4, F5], [F6, F7, F8, F9, F10, F11, F12, F14, F15].

Referring now to FIGS. 4A and 4B, an exemplary node feature vector table 400A and an exemplary edge feature vector table 400B are illustrated, in accordance with some embodiments of the present disclosure. FIGS. 4A and 4B are explained in conjunction with FIGS. 1-3A-E. In an embodiment, the node feature vector table 400A and the edge feature vector table 400B may be generated for each of the extracted sub-graphs 300D and 300E. The node feature vector table 400A and edge feature vector table 400B may be determined for the sub-graph 300E. The node feature vector table 400A and the edge feature vector table 400B include various attributes corresponding to the sub-graph 300E that may captured from the 3D model.

Further, a first column of the node feature vector table 400A includes face IDs 401a (F7-F15 corresponding to the faces F 307 to F 315). Further, other columns of the node feature vector table 400A include various attributes including face type 402a, face convexity 403a, face area 404a, convex inner loop 405a, and concave inner loop 406a. Here, the possible values for the face type 402a may be a not connected, a planar, a cylindrical, a toroid, a spherical, a spline, and a conical type, and corresponding scores may be ‘0’, ‘1’, ‘2’, ‘3’, ‘4’, ‘5’, ‘6’, respectively. Further, possible values for the face convexity 403a may include a smooth face, a convex face, and a concave face, and corresponding scores may be ‘0’, ‘1’, and ‘2’, respectively. The attribute face area 404a is a normalized area of the face for a particular feature. Further, the convex linear loop 405a may be represented by either ‘0’ or ‘1’ which signifies the presence or absence of a convex inner loop, respectively. The attribute concave inner loop 406a may also be represented by either ‘0’ or ‘1’, signifying presence or absence of a concave inner loop, respectively.

Similarly, a first column of the edge feature vector table 400B may be determined for the sub-graph 300E and includes edge IDs E12-E20. And, other columns of the node feature vector table 400A includes various attributes including edge type, edge convexity, inner loop edge area, outer loop edge, and edge angle. Possible edgy type may be a not connected edge, a line edge, a circle type edge, an elliptical type of edge, and a spline edge, and possible corresponding values may be ‘0’, ‘1’, ‘2’, ‘3’, and ‘4’, respectively. Further, the edge connectivity may include a not connected category, a convex, a smooth, or a concave category, their corresponding values may be ‘0’, ‘1’, ‘2’, and ‘3’, respectively. Further, the inner loop edge and outer loop edge may be represented by either ‘0’ or ‘1’, which signifies that the edge is a part of inner loop and/or outer loop. The node feature vector 400A and the edge feature vector 400B may be transmitted to a feature classification module (same as the feature classification module 108). It should be noted that the face ID and the edge ID are unique face and edge IDs.

Further, the dataset generated for training the GNN module 108a may be represented as graphs. Each graph which is a manufacturing feature is associated with a label value which corresponds to a type of a feature. The nodes of the graph may correspond to the faces of the feature. It should be noted that two nodes may be connected in the graph if and only if the corresponding faces share an edge in the 3D model. The graph may be represented by an adjacency attribute matrix (such as, the adjacency attribute matrix 300B) of a dimension n*n, where ‘n’ is the number of nodes in the graph. Each node of the graph includes an associated feature vector which captures the attributes of a face, whereas each edge of the graph captures the edge level attributes from the 3D model. The node feature is derived from the FIG. 4A depending on B-Rep faces that are part of the manufacturing features. Also, edges of the 3D model which are induced by the selected nodes may be considered and form a part of the manufacturing feature.

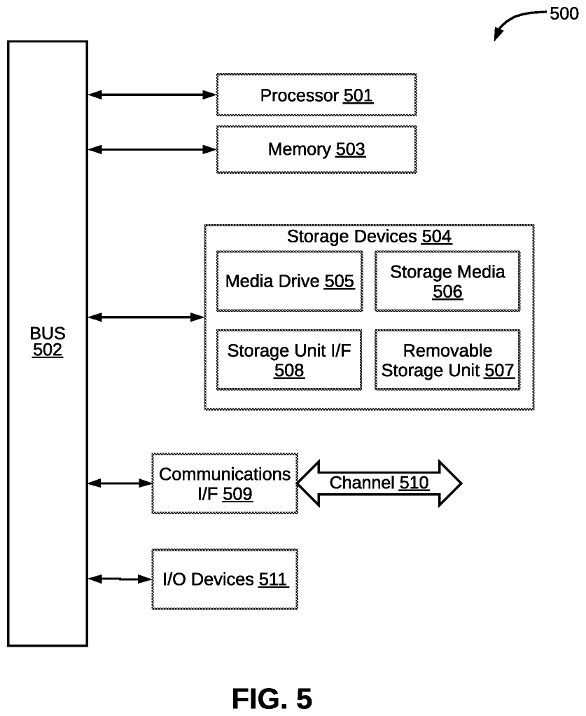

The disclosed methods and systems may be implemented on a conventional or a general-purpose computer system, such as a personal computer (PC) or server computer. Referring now to FIG. 5, an exemplary computing system 500 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 500 may include one or more processors, such as a processor 501 that may be implemented using a general or special purpose processing engine such as, for example, a microprocessor, microcontroller or other control logic. In this example, the processor 501 is connected to a bus 502 or other communication medium. In some embodiments, the processor 501 may be an Artificial Intelligence (AI) processor, which may be implemented as a Tensor Processing Unit (TPU), or a graphical processor unit, or a custom programmable solution Field-Programmable Gate Array (FPGA).

The computing system 500 may also include a memory 503 (main memory), for example, Random Access Memory (RAM) or other dynamic memory, for storing information and instructions to be executed by the processor 501. The memory 503 also may be used for storing temporary variables or other intermediate information during execution of instructions to be executed by the processor 501. The computing system 500 may likewise include a read only memory (“ROM”) or other static storage device coupled to bus 502 for storing static information and instructions for the processor 501.

The computing system 500 may also include a storage device 504, which may include, for example, a media drives 505 and a removable storage interface. The media drive 505 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 506 may include, for example, a hard disk, magnetic tape, flash drive, or other fixed or removable medium that is read by and written to by the media drive 505. As these examples illustrate, the storage media 506 may include a computer-readable storage medium having stored there in particular computer software or data.

In alternative embodiments, the storage devices 504 may include other similar instrumentalities for allowing computer programs or other instructions or data to be loaded into the computing system 500. Such instrumentalities may include, for example, a removable storage unit 507 and a storage unit interface 508, such as a program cartridge and cartridge interface, a removable memory (for example, a flash memory or other removable memory module) and memory slot, and other removable storage units and interfaces that allow software and data to be transferred from the removable storage unit 507 to the computing system 500.

The computing system 500 may also include a communications interface 509. The communications interface 509 may be used to allow software and data to be transferred between the computing system 500 and external devices. Examples of the communications interface 509 may include a network interface (such as an Ethernet or other NIC card), a communications port (such as for example, a USB port, a micro USB port), Near field Communication (NFC), etc. Software and data transferred via the communications interface 509 are in the form of signals which may be electronic, electromagnetic, optical, or other signals capable of being received by the communications interface 509. These signals are provided to the communications interface 509 via a channel 510. The channel 510 may carry signals and may be implemented using a wireless medium, wire or cable, fiber optics, or other communications medium. Some examples of the channel 510 may include a phone line, a cellular phone link, an RF link, a Bluetooth link, a network interface, a local or wide area network, and other communications channels.

The computing system 500 may further include Input/Output (I/O) devices 511. Examples may include, but are not limited to a display, keypad, microphone, audio speakers, vibrating motor, LED lights, etc. The I/O devices 511 may receive input from a user and also display an output of the computation performed by the processor 501. In this document, the terms “computer program product” and “computer-readable medium” may be used generally to refer to media such as, for example, the memory 503, the storage devices 504, the removable storage unit 507, or signal(s) on the channel 510. These and other forms of computer-readable media may be involved in providing one or more sequences of one or more instructions to the processor 501 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into the computing system 500 using, for example, the removable storage unit 507, the media drive 505 or the communications interface 509. The control logic (in this example, software instructions or computer program code), when executed by the processor 501, causes the processor 501 to perform the functions of the invention as described herein.

Thus, the present disclosure may overcome drawbacks of traditional systems discussed before. The disclosed method and system in the present disclosure uses a GNN model for recognizing features. The GNN model does not employ any rules, instead learns the feature representation for feature classification. Thus, adding any new feature only requires retraining the GNN model with additional examples (for example, additional features or graphs) included in the training data. The GNN model may be able to classify any new features with minimal efforts. Since the disclosure employs GNN model for feature classification, the addition of new features may be added in a fraction of time as compared to the rule-based methods. Moreover, inexperienced people are also able to use the implementation as it does not require expert knowledge and in-depth understanding FR, CAD/CAM, B-rep, which is typically required for new feature addition in heuristic-based systems. Further, the implementation provides a customization option to modify the training data, thereby gives flexibility to provide specialized solution which is rarely a possibility in traditional systems. Further, the present implementation is inexpensive and effective even for minor variation in features. Moreover, the present implementation may be used for recognizing feature of a variety of manufacturing process like Sheetmetal, Machining, casting, injection molding, and the like.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

What is claimed is:

1. A method for extracting and classifying manufacturing features from a three-dimensional (3D) model of a product, the method comprising:
generating, by a feature identification device, a graph corresponding to the product based on the 3D model of the product, wherein the graph comprises a plurality of nodes corresponding to faces of the product and a plurality of links corresponding to edges of the product, and wherein generating the graph comprises determining an adjacency attribute matrix from the 3D model of the product;
assigning, by the feature identification device, a plurality of scores to each of the plurality of links based on each of a plurality of predefined criteria, based on corresponding edges of the product in the 3D model of the product;
determining, by the feature identification device, a cumulative score for each of the plurality of links based on the plurality of scores assigned to the each of the plurality of links;
extracting, by the feature identification device, sub-graphs from the graph by discarding one or more links from the plurality of links when the cumulative score of each of the one or more links exceeds a predefined threshold value;
for each of the sub-graphs, extracting, by the feature identification device, a set of node parameters and a set of edge parameters from the 3D model of the product;
for each of the sub-graphs, determining, by the feature identification device, a node feature vector based on the set of node parameters and an edge feature vector based on the set of edge parameters; and
for each of the sub-graphs, determining, by the feature identification device, a type of manufacturing feature based on corresponding node feature vector and the edge feature vector using a Graph Neural Network (GNN) model, wherein a confidence score is assigned to each of the subgraphs corresponding to the type of manufacturing feature.

2. The method of claim 1, wherein the 3D model is a boundary representation (B-rep) based Computer Aided Design (CAD) model.

3. The method of claim 1, wherein:
the set of node parameters comprises a face type, face smoothness, face convexity, face area, and presence of inner loop; and
the set of edge parameters comprises an edge type, edge convexity, inner loop edge, outer loop edge, and edge angle.

4. The method of claim 1, wherein the adjacency attribute matrix comprises a plurality of rows and a plurality of columns corresponding to faces of the product, and a plurality of matrix elements representing connection between two faces of the product.

5. The method of claim 1, wherein the plurality of predefined criteria comprises presence of a loop type, convexity of vertices, and neighbour convexity variation.

6. The method of claim 1, wherein the GNN model comprises a set of graph convolution layers, a set of corresponding pooling layers, and a fully connected dense layer, and wherein each of the set of convolution layers is followed by each of the set of corresponding pooling layer.

7. The method of claim 1, wherein the GNN model uses a negative log-likelihood loss function to determine the type of manufacturing feature, and wherein the type of manufacturing feature comprises at least one of a pocket, a slot, a boss, a groove, and a hole.

8. The method of claim 1, wherein the GNN model is trained using a dataset comprising a set of graphs that represents a plurality of manufacturing features.

9. A system for extracting and classifying manufacturing features from a three-dimensional (3D) model of a product, the system comprising:
a processor; and
a memory communicatively coupled to the processor, wherein the memory stores processor-executable instructions, which, on execution, cause the processor to:
generate a graph corresponding to the product based on the 3D model of the product, wherein the graph comprises a plurality of nodes corresponding to faces of the product and a plurality of links corresponding to edges of the product, and wherein generating the graph comprises determining an adjacency attribute matrix from the 3D model of the product;
assign a plurality of scores to each of the plurality of links based on each of a plurality of predefined criteria, based on corresponding edges of the product in the 3D model of the product;
determine a cumulative score for each of the plurality of links based on the plurality of scores assigned to the each of the plurality of links;
extract sub-graphs from the graph by discarding one or more links from the plurality of links when the cumulative score of each of the one or more links exceeds a predefined threshold value;
for each of the sub-graphs, extract a set of node parameters and a set of edge parameters from the 3D model of the product;
for each of the sub-graphs, determine a node feature vector based on the set of node parameters and an edge feature vector based on the set of edge parameters; and
for each of the sub-graphs, determine a type of manufacturing feature based on corresponding node feature vector and the edge feature vector using a Graph Neural Network (GNN) model, wherein a confidence score is assigned to each of the subgraphs corresponding to the type of manufacturing feature.

10. The system of claim 9, wherein the 3D model is a boundary representation (B-rep) based Computer Aided Design (CAD) model.

11. The system of claim 9, wherein:
the set of node parameters comprises a face type, face smoothness, face convexity, face area, and presence of inner loop; and
the set of edge parameters comprises an edge type, edge convexity, inner loop edge, outer loop edge, and edge angle.

12. The system of claim 9, wherein the adjacency attribute matrix comprises a plurality of rows and a plurality of columns corresponding to faces of the product, and a plurality of matrix elements representing connection between two faces of the product.

13. The system of claim 9, wherein the plurality of predefined criteria comprises presence of a loop type, convexity of vertices, and neighbour convexity variation.

14. The system of claim 9, wherein the GNN model comprises a set of graph convolution layers, a set of corresponding pooling layers, and a fully connected dense layer, and wherein each of the set of convolution layers is followed by each of the set of corresponding pooling layer.

15. The system of claim 9, wherein the GNN model uses a negative log-likelihood loss function to determine the type of manufacturing feature, and wherein the type of manufacturing feature comprises at least one of a pocket, a slot, a boss, a groove, and a hole.

16. The system of claim 9, wherein the GNN model is trained using a dataset comprising a set of graphs that represents a plurality of manufacturing features.

17. A non-transitory computer-readable medium storing computer-executable instructions for extracting and classifying manufacturing features from a three-dimensional (3D) model of a product, the computer-executable instructions configured for:
generating a graph corresponding to the product based on the 3D model of the product, wherein the graph comprises a plurality of nodes corresponding to faces of the product and a plurality of links corresponding to edges of the product, and wherein generating the graph comprises determining an adjacency attribute matrix from the 3D model of the product;
assigning a plurality of scores to each of the plurality of links based on each of a plurality of predefined criteria, based on corresponding edges of the product in the 3D model of the product;
determining a cumulative score for each of the plurality of links based on the plurality of scores assigned to the each of the plurality of links;
extracting sub-graphs from the graph by discarding one or more links from the plurality of links when the cumulative score of each of the one or more links exceeds a predefined threshold value;
for each of the sub-graphs, extracting a set of node parameters and a set of edge parameters from the 3D model of the product;
for each of the sub-graphs, determining a node feature vector based on the set of node parameters and an edge feature vector based on the set of edge parameters; and
for each of the sub-graphs, determining a type of manufacturing feature based on corresponding node feature vector and the edge feature vector using a Graph Neural Network (GNN) model, wherein a confidence score is assigned to each of the subgraphs corresponding to the type of manufacturing feature.

18. The non-transitory computer-readable medium of the claim 17, wherein: wherein:
the set of node parameters comprises a face type, face smoothness, face convexity, face area, and presence of inner loop; and
the set of edge parameters comprises an edge type, edge convexity, inner loop edge, outer loop edge, and edge angle.

19. The non-transitory computer-readable medium of the claim 17, wherein the plurality of predefined criteria comprises presence of a loop type, convexity of vertices, and neighbour convexity variation.

20. The non-transitory computer-readable medium of the claim 17, wherein:
the GNN model comprises a set of graph convolution layers, a set of corresponding pooling layers, and a fully connected dense layer, and wherein each of the set of convolution layers is followed by each of the set of corresponding pooling layer;
the GNN model uses a negative log-likelihood loss function to determine the type of manufacturing feature, and wherein the type of manufacturing feature comprises at least one of a pocket, a slot, a boss, a groove, and a hole; and
the GNN model is trained using a dataset comprising a set of graphs that represents a plurality of manufacturing features.
